(19) United States
(12) Patent Application Publication
(10) Pub. No.: US 2003/0187708 A1
(43) Pub. Date: Oct. 2, 2003

(54) Simulation and optimization system for retail store performance

(75) Inventors: Cem M. Baydar, Prospect Heights, IL (US); Valery A. Petrushin, Buffalo Grove, IL (US); Anatole V. Gershman, Chicago, IL (US)

Correspondence Address: BRINKS HOFER GILSON & LIONE, P.O. BOX 10395, CHICAGO, IL, 60611, US

(73) Assignee: Accenture Global Services GmbH

(21) Appl. No.: 10/189,701

(22) Filed: Jul. 3, 2002

Related U.S. Application Data
(60) Provisional application No. 60/369,448, filed on Apr. 1, 2002.

(51) Int. Cl. G06F 17/60

(52) U.S. Cl. 705/7

(57) ABSTRACT

A simulation and optimization system improves or optimizes the performance of a retail store. A simulator provides individual customer discounts in response to input parameters, such as price variables, customer models, and user inputs. The product price variables include purchasing costs, inventory costs, and replenishment rates. The customer models represent customer shopping behaviors. The user inputs include a store strategy providing the relative importance of profits, sales volume, and customer loyalty.

### CROSS REFERENCE TO RELATED APPLICATIONS

This application claims priority to U.S. Provisional Patent Application No. 60/369,448 entitled “One-To-One Marketing” and filed Apr. 1, 2002, which is incorporated by reference in its entirety.

This application is related to U.S. patent application Ser. No. ______, entitled “Individual Discount System for Optimizing Retail Store Performance” filed on the same day as the present application and assigned to the same assignee as the present application.

### FIELD OF THE INVENTION

This invention generally relates to marketing systems for giving individual discounts to customers. More particularly, this invention relates to a system for simulating and optimizing the performance of a retail store in relation to profits, sales volume, and customer satisfaction.

### BACKGROUND OF THE INVENTION

In marketing, there are several approaches to customer relationship management. These approaches include clustering and one-to-one marketing. Clustering groups or segments customers by one or more attributes such as demographics. These attributes may have little correlation to the buying behavior of the customer. Further, not all customers in a particular group would necessarily have the same buying behavior.

One-to-one marketing is a customer relationship management system that aims to build customer loyalty by trying to sell as many as products as possible to one customer at a time. One-to-one marketing aims to treat each customer as an individual rather than a part of a segment. Frequent flyer programs offered by airliners are one example of one-to-one marketing. There are similar types of loyalty programs offered by on-line music retailers.

Grocery retail is another area for application of one-to-one marketing. In the grocery business, almost every customer is a repeat buyer and grocery goods are consumed at an essentially constant rate. Usually, there is sufficient data to model each regular customer's shopping behavior. There are various modeling directions to model individual customer behaviors including finite mixture models and multivariate continuous models. In finite mixture models, shopping behavior is obtained by combining basic transaction behaviors obtained from the data. However, many finite mixture models provide poor approximations. Multivariate continuous models typically use Bayesian Reasoning, Markov Chain Monte Carlo, and other methods incorporating observable household characteristics data, such as demographics.

The Internet is another medium in which one-to-one marketing can occur. Online grocery stores can benefit from targeted couponing by analyzing their customer's shopping, behavior and even their customers' browsing behavior using click-stream data. Several software applications are available to log a user's browsing movements on a website. These movements can later be used for customer modeling. In the retail industry, most supermarkets use customer loyalty cards to obtain market data and provide documents. Several companies have started to analyze this data for one-to-one marketing. Some supermarkets have identified over 5,000 “needs segments” among their customers and have improved inventory management, product selection, pricing and discounts. Other supermarkets have more than 1.8 terabytes of market data and are able to analyze markets to obtain customer purchasing behavior.

### SUMMARY

This invention provides a simulation and optimization system to improve or optimize the performance of a retail store. The simulation and optimization system provides individual customer discounts in response to models of each customer's shopping behavior, the product price variables, and the store's strategy to improve performance.

In one aspect, the simulation and optimization system comprises a simulation connected to a customer-product database, a user input device, and an optimization system. The simulation provides a result in response to input parameters. The result includes at least one discount for each customer to optimize performance of the retail store.

In a method for simulating and optimizing the performance of a retail store, the retail store is modeled. A store strategy is defined. One or more customer models are generated. One or more agent-based simulations are performed. One or more individual discounts are identified to optimize the retail store performance.

Other systems, methods, features, and advantages of the invention will be or will become apparent to one skilled in the art upon examination of the following figures and detailed description. All such additional systems, methods, features, and advantages are intended to be included within this description, within the scope of the invention, and protected by the accompanying claims.

### BRIEF DESCRIPTION OF THE FIGS.

The invention may be better understood with reference to the following figures and detailed description. The components in the figures are not necessarily to scale, emphasis being placed upon illustrating the principles of the invention. Moreover, like reference numerals in the figures designate corresponding parts throughout the different views.

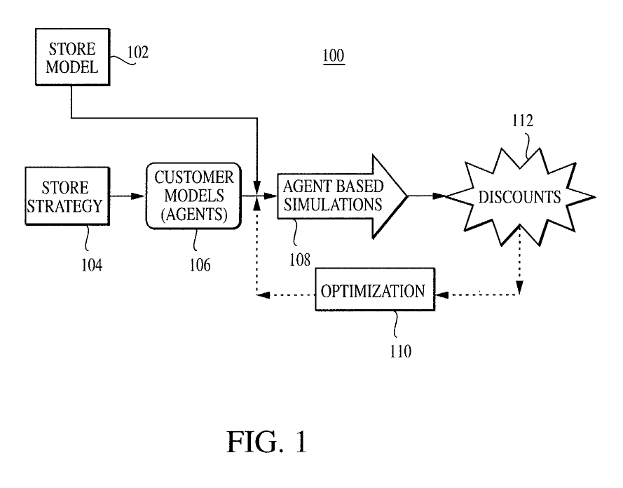

FIG. 1 represents a block diagram or flow chart of a simulation and optimization system according to an embodiment.

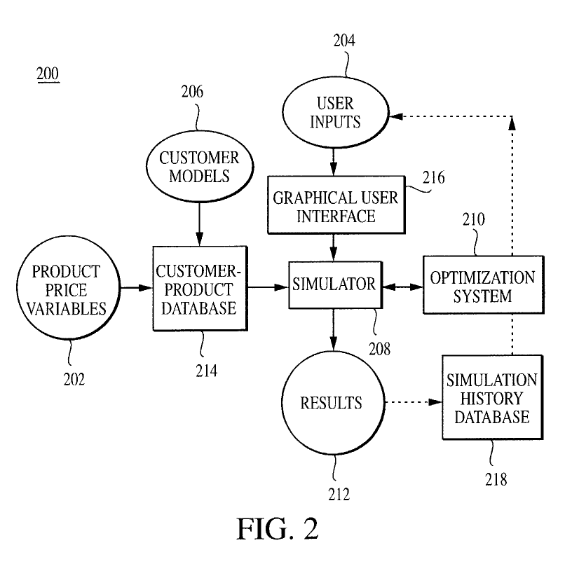

FIG. 2 represents a block diagram or flow chart of a simulation and optimization system according to another embodiment.

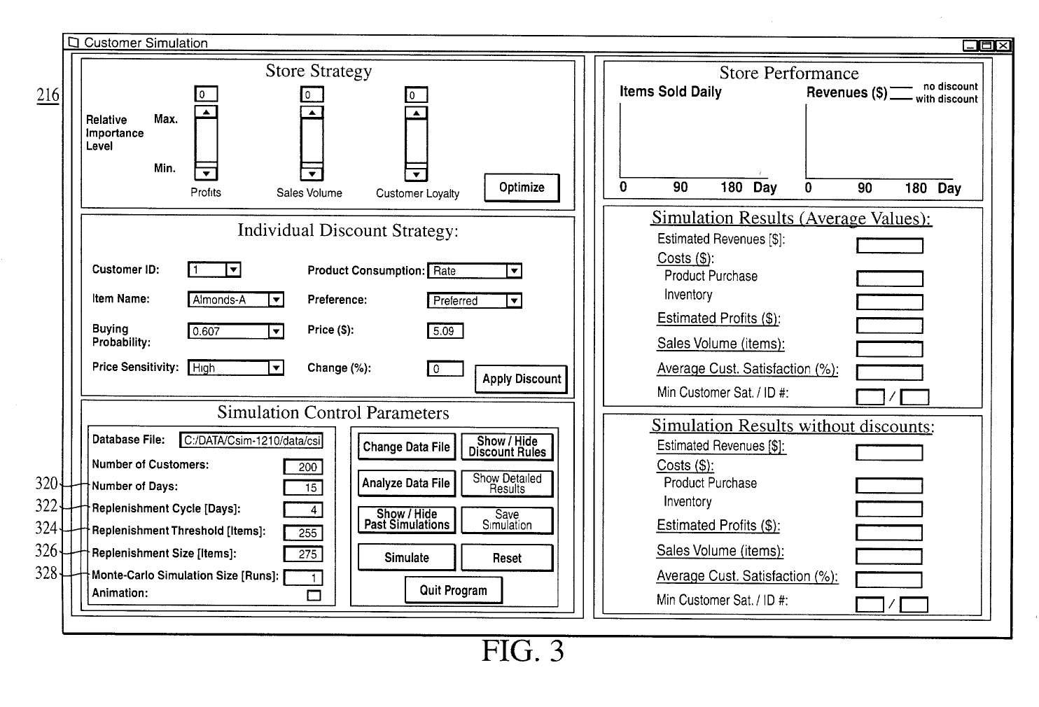

FIG. 3 represents a view of a Graphical User Interface (GUI).

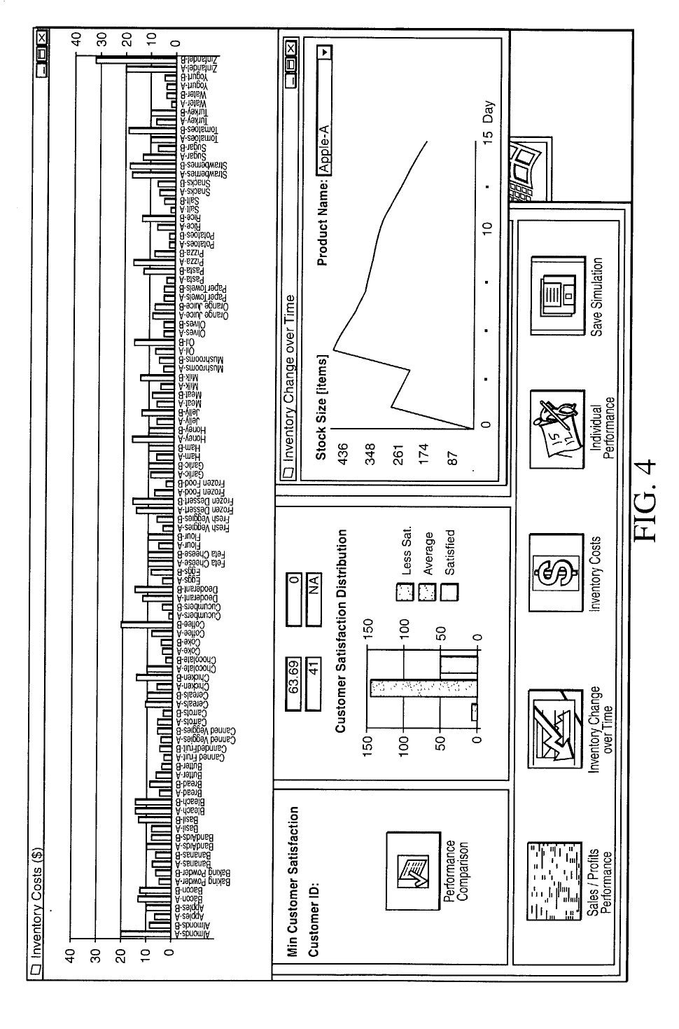

FIG. 4 represents an output screen showing the results of the simulation and optimization system.

### DETAILED DESCRIPTION OF THE PREFERRED EMBODIMENTS

FIG. 1 represents a block diagram or flow chart of a simulation and optimization system 100 according to an embodiment. The simulation and optimization system 100 optimizes a retail store's performance by giving individual discounts. A store model is constructed 102 by modeling the products in the store, the purchasing and stocking costs of the products, and the replenishment rates of the products. A store strategy is defined 104 by the relative importance of three factors—profits, sales volume, and customer loyalty. Other factors may be used. Customer models or agents are generated 106 from transactional and/or other data. These models represent individual customer shopping behaviors, such as shopping frequency, buying probability of each product, and the customer's satisfaction function. Agent-based simulations identify 108, optionally with input from an optimization system 110 and the store model 102, the set of discounts 112 for each customer to optimize the store's performance. The optimization system determines 110 the optimal discounts 112 to maximize or increase the store's performance in response to the store strategy 104. While a particular configuration is shown or discussed, other configurations may be used including those with fewer or additional components and operations.

The simulation and optimization system 100 uses an agent-based modeling and simulation approach that is different from a store optimization research approach, which uses complex mathematical equations to account for revenues, costs, and sales volume. Agent-based modeling uses only equations governing the micro-social structure (i.e., shopping behavior of each individual). The overall macroscopic structure of the system is generated from the bottom-up. In an agent-based approach, the revenue, costs, and sales volume are determined by summing up each individual customer's shopping activity such as his or her shopping frequency and spending.

FIG. 2 represents a block diagram or flowchart of a simulation and optimization system 200 according to another embodiment. The simulation and optimization system 200 has a simulator 208 that provides results 212 in response to inputs from a customer-product database 214, a Graphical User Interface (GUI) 216, and an optimization system 210. The optimization system 210 determines the optimal or better discounts for each customer to satisfy a store strategy. While a particular configuration is shown and discussed, the simulation and optimization system 200 may have other configurations including those with fewer additional components. The GUI 216 accepts user inputs 204 from a plurality of users or managers of the store whose performance optimization is desired.

The customer-product database 214 holds outputs from product price variables 202 and customer models 206. In one aspect, the customer-product database 214 is implemented by Microsoft® Access® software from Microsoft Corporation. Other database formats may be used. The product price variables 202 include the purchasing costs and the stock keeping cost for each product. The purchasing cost is the acquisition cost of that product to the store. The stock keeping or inventory cost is the cost for the store to keep one quantity of that product for one day.

Customer models 206 are mathematical representations of shopping behavior for each customer. A customer model can be composed of one or more parameters such as shopping frequency (for example, once per week on Saturdays), buying probability for each product, consumption rate of each product (for example, two gallons of milk per week), price sensitivity for each product, product dependency or substitutions, and a satisfaction function.

The customer models 206 are generally probabilistic, meaning that shopping behavior can be anticipated up to a certain possibility. For example, if the customer comes into the store, there is a 90% probability that the customer will buy milk. Price sensitivity defines the customer's response to a price change. For example, if the customer is highly price sensitive to a price change in ground beef, a moderate discount would increase his probability of buying ground beef. A customer may have different price sensitivities for each product. For example, a customer who is highly price sensitive to beef may be low price sensitive to eggs.

Product dependencies represent each customer's product groups for substitutes and complements. With substitute products, if a customer buys one product, the customer will not buy the other product. For a particular customer, for example, multiple products of Coca-Cola may be substitutes for each other, and the customer may buy either of several Coca-Cola products. When a store manager gives a discount coupon to that customer for one product to increase the buying probability of that product, the store manager also decreases the buying probability of another product for that customer. With complementary products, the dependency relationship is directly proportional. For example, if buying macaroni increases the buying probability of cheddar cheese (for preparation of macaroni and cheese), then having a discount on either of macaroni or cheddar cheese will increase or complement the buying probability of the other product.

A satisfaction function represents a customer's satisfaction level after shopping is completed. The satisfaction function may depend on favorite items and their prices. For example, a customer may not be satisfied fully if a favorite product is more expensive than previously believed. The satisfaction function level is represented as a percentage. For completely satisfied customers, the satisfaction level is 100. The satisfaction level affects the next arrival time of the customer at the store. The customer may skip shopping at the store if the satisfaction level is too low.

FIG. 3 represents a view of the GUI 216 that gathers inputs supplied by a user and provides these inputs to the simulator 208. The GUI 216 may be another user input device. The user may input the number of days to simulate (simulation period) 320, the replenishment cycle of the products 322, the replenishment threshold of the products 324, the replenishment site of the products 326, the number of times to simulate one shopping day 328, and the store strategy 104. Other inputs or parameters may be also be entered by a user.

The replenishment parameters determine the supply rate of a product, such as the truck arrival rate to resupply the store with the product. For example, the replenishment rate may be four days, the replenishment threshold may be 200 items, and the replenishment site may be 300 items. In this example, the product stock or amount in the store is checked once every four days. If the product stock is less than 200 items, another 300 items are added.

Since shopping behavior is probabilistic, the shopping process is simulated several times to obtain average output values and other statistical properties, such as standard deviations. The user can enter the simulation size as an input.

In addition, a user can supply the store strategy to be optimized or individual discounts. The store strategy is in terms of profits, sales volume, and customer satisfaction, which may be adjusted. The store strategy may be based on other or different parameters. User defined individual discounts may be used to simulate and compare store performance with a new discount or other discount price strategy. The user can also retrieve past simulation parameters and related results from the simulation history database 218 (See FIG. 2), which also may use Microsoft*) Access® or another database format.

In FIG. 2, the simulator 208 simulates the shopping behavior for a period of time and in response to the various input parameters. A typical simulation of a shopping day for each individual customer at a retail store includes: the customer comes to the store; the customer looks at the prices of the item in the store; the customer buys products based on the buying probability, the satisfaction function or the satisfaction level; and the customer leaves the store. Buying probability is influenced by discounts and the customer's price sensitivity towards particular products. Other simulations may be used.

The simulation is applied for all customers who come to the store on the same day. The numerical method used in the simulation is Monte Carlo simulation. Other numerical methods may be used. The sampled process parameters of the simulation include each customer's shopping behavior, which consists of price sensitivities, buying probabilities, and the likelihood of arrival to the store. Other parameters may be used. This simulation can be repeated several times depending on user's preference to obtain an average, a standard deviation, and other statistical values for the shopping process.

FIG. 4 represents an output screen showing results of the simulation and optimization system. For details of the optimization system, see related patent application Serial No. ______, entitled Individual Discount System for Optimizing Retail Store Performance, filed on the same day as the present application and assigned to the same assignee as the present application. The results or outputs include average and standard deviation values for estimated revenues, costs (inventory and product purchase), sales volume, customer satisfaction, and minimum customer satisfaction. The results also include the sales and profit performance compared to a non-discounted pricing strategy, as well as the inventory change of each product over time and the inventory cost of each product. For each customer, the results or outputs include the discounted products and discounted amount, the average satisfaction level, and the average quantity bought of each product. In addition, for each customer, the results also include the change in average spending compared to the non-discount strategy as well as the change in average satisfaction in percent compared to the non-discount strategy. Other results may be obtained. These results may be saved in the simulation history database 218 (see FIG. 2).

Various embodiments of the invention have been described and illustrated. However, the description and illustrations are by way of example only. Other embodiments and implementations are possible within the scope of this invention and will be apparent to those of ordinary skill in the art. Therefore, the invention is not limited to the specific details, representative embodiments, and illustrated examples in this description. Accordingly, the invention is not to be restricted except in light as necessitated by the accompanying claims and their equivalents.

What is claimed is:

1. A simulation and optimization system for a retail store comprising:
a simulator connected to a customer-product database, a user input device, and an optimization system,
where the simulator provides a result in response to at least one input parameter from the customer-product database, the user input device, and the optimization system, and
where the result include at least one discount for each customer to optimize performance of the retail store.

2. The simulation and optimization system according to claim 1, where the customer-product database comprises product price variables and customer models.

3. The simulation and optimization system according to claim 2, where the produce price variables comprise at least one of purchasing cost and inventory cost.

4. The simulation and optimization system according to claim 2, where the customer models comprise at least one of a shopping frequency, a buying probability, a consumption rate, a price sensitivity, a product dependency, and a satisfaction function.

5. The simulation and optimization system according to claim 1, where the user input device comprises a Graphical User Interface (GUI).

6. The simulation and optimization system according to claim 5, where the simulator receives at least one of a simulation period, a simulation size, a replenishment parameter, and a store strategy from the GUI.

7. The simulation and optimization system according to claim 1, where the simulator includes a Monte-Carlo simulation.

8. A method for simulating and optimizing the performance of a retail store comprising:
modeling the retail store;
defining a store strategy;
generating at least one customer model;
performing at least one agent-based simulation; and
identifying at least one individual discount for each customer, the at least one discount to optimize the retail store performance.

9. The method according to claim 8, where modeling the retail store further comprises the modeling of at least one of the products in the store, the purchasing and stocking costs of the products, and the replenishment rates of the products.

10. The method according to claim 8, where the store strategy is responsive to at least one of profits, sales volume, and customer loyalty.

11. The method according to claim 8, where the customer model represents an individual shopping behavior.

12. The method according to claim 11, where the individual shopping behavior is at least one of a shopping frequency, a buying probability of each product, and a customer's satisfaction level.
